(19) United States
(12) Patent Application Publication
(10) Pub. No.: US 2024/0349754 A1
(43) Pub. Date: Oct. 24, 2024

(54) MEAT-ANALOGUE COMPOSITION

(71) Applicant: AAK AB, Malmo (SE)

(72) Inventors: Jeroen DEMEURISSE, Malmo (SE); Hanne MASURE, Malmo (SE)

(21) Appl. No.: 18/684,971

(22) PCT Filed: Aug. 26, 2022
(86) PCT No.: PCT/SE2022/050771

§ 371 Date: Feb. 20, 2024

(30) Foreign Application Priority Data
Aug. 27, 2021 (SE) 2130229-4

(51) Int. Cl. A23J 3/22; A23J 3/14; A23L 5/40; A23L 29/00; A23L 29/10; A23L 29/20; A23L 29/30

(52) U.S. Cl. CPC A23J 3/227; A23J 3/14; A23L 5/40; A23L 29/015; A23L 29/10; A23L 29/20; A23L 29/30

(57) ABSTRACT

A meat analogue composition comprising from 2.0% to 20.0% by weight of a fat composition; from 5.0% to 30.0% by weight of a non-animal protein; from 30.0% to 70.0% by weight of water; from 0.01% to 5% by weight of one or more colourants; and from 0.005% to 5% by weight of one or more alkali ingredients.

### FIELD OF THE INVENTION

The invention relates to meat analogue compositions comprising a fat composition, non-animal protein and water, and the use of said meat analogue compositions in food products. In particular, the invention relates to the browning of such meat analogue compositions when cooked.

### BACKGROUND OF THE INVENTION

There is an increasing demand for plant-based foods due to consumers' increasing desire to eat healthy, sustainably sourced food products and to generally lower their meat intake. This has led to the development of meat-analogues; meat-free, vegetarian or vegan food products which mimic certain qualities of meat or meat-based products, such as the texture, taste and/or appearance.

Many different types of meat-analogues are available, such as those based on tofu, lentils and beans, some of which aim to mimic meat completely in terms of its look when uncooked, as well as sizzling and browning during cooking, bleeding, colour, texture and taste. One example of such meat-analogues is plant-based burgers. Products such as plant-based sausages, meat balls, meat loaf and nuggets are also known in the art.

The typical composition of known meat-analogues is 50 to 60% water, 10 to 25% proteins (such as soy, pea, potato and wheat), 5 to 20% fat, 0 to 10% carbohydrates, as well as flavourings and colourings. Various fats have been proposed for use in meat analogue compositions. Coconut oil, palm oil, sunflower oil and rapeseed oil are examples of vegetable derived fats that have been proposed for use in meat analogue compositions. In order to produce a desirable meat-analogue, it is important that the final product have an appealing look, taste, texture and mouthfeel, and have similar look (preferably both before and after cooking), taste, texture and mouthfeel to meat. Particular non-animal fats, non-animal derived proteins and other ingredients are selected so that the meat analogue composition has properties that mimic real meat as closely as possible.

Various colourants such as dyes are used in meat analogue compositions so that the composition resembles meat. In particular, dyes and colouring agents are used to give the raw uncooked meat analogue composition the appearance of real raw meat by imparting a red colour to the uncooked compositions. Such colourants include natural colourants; nature-identical colourants; synthetic colourants; and colouring foodstuffs. Examples of colourants include anthocyanins found in sweet potato and black carrot; betanins found in red beet; carotenoids found in paprika; sources of lycopene such as red tomato; and carminic acid.

Some known colourants used in meat analogue compositions to provide a red colour to the uncooked composition either fade gradually after manufacture of the meat analogue composition such that by the time of cooking the meat analogue composition no longer resembles the colour of uncooked meat; or the colourants do not degrade upon cooking of the meat analogue composition-both of these are highly undesirable to consumers. In the latter scenario, even where the meat analogue compositions contain a browning agent, it has been found that whilst browning may occur to the cooked food product, the red colourant remains present and is not broken down meaning that the cooked meat analogue product still has a strong red or coloured appearance. This means that the cooked meat product less closely resembles the brown colour of cooked real meat products. This particular phenomenon is shown in FIG. 3.

Betanins such as red beet have been used as colourants in meat analogue products to provide a red colour to the uncooked products. However, it has been found that the red colour of red beet fades over time after manufacture of the composition. As a result, by the time meat analogue products containing red beet are cooked, the products have often lost their red colour due to the effects of light breaking down the dye. Another disadvantage of red beet is that even in the case that some red colour is maintained until the point of cooking, the red colour is not effectively broken down upon cooking meaning that the red colour remains in the cooked meat analogue product.

Other colourants that are less susceptible to breaking down over time have been used to maintain a red colour of the meat analogue compositions up until the point of cooking. Such colourants include various anthocyanins, carotenoids and lycopene such as the colourants discussed above. The problem with the use of such colourants is that they are heat and light stable and are not broken down upon cooking meaning that the cooked meat analogue products containing said colourants have an undesirable red appearance.

Currently known commercial meat analogue products include those containing an apple or pomegranate extract as a browning agent and a small amount of red beet to provide a raw red colour. By using a small amount of red beet only, a brown colour can be obtained upon cooking. The downside of this solution is that not enough red beet is used to provide a proper red colour to the raw products and the raw product has a pale pink colour which is optically undesirable (as shown by the product depicted in FIG. 2). As discussed above, another downside is that the colour of the red beet fades over time. Another known solution is the use of leghemoglobin which is a protein made using a genetically modified yeast. The downside of this solution is that leghemoglobin is not currently allowed for use in food products in Europe. Leghaemoglobin is also a complex protein macromolecule with a complicated manufacturing process.

It will be appreciated that it is highly important for such meat analogues to be able to mimic the browning effect of meat when it is cooked. When meat is cooked by various processes such as frying, a Maillard reaction occurs between reducing sugars present in the meat and amino acids present in the meat proteins. The Maillard reaction is a form of non-enzymatic browning and causes browning in the cooked meat product. The Maillard reaction and browning effect are responsible for a lot of the highly appetizing mouth feel, aroma and flavour of cooked meats. FIG. 1 shows the colour change that occurs upon cooking a meat burger and the browning effect of cooking. It is highly desirable for this browning effect in meat to be effectively mimicked in meat analogue compositions when cooked. To help aid in achievement of the browning effect due to the Maillard reaction, certain additives may be included to promote the Maillard reaction, or reducing sugars and/or proteins and their precursors may be added to the food products to participate in the reaction and contribute towards the browning effect upon cooking. Such food additives are known as browning agents and include compounds such as carbonyl compounds, various sugars, citric acid and liquid smoke compositions. Various browning agents have been used in meat analogue compositions to provide a browning effect upon cooking of the composition and to promote the Maillard reaction so that the cooked product resembles the browned effect of cooked meat. Apple extract or pomegranate extract have been used in meat analogue compositions as browning agents. These additives comprise polyphenol oxidase enzymes which oxidise phenolic compounds such as anthocyanins into compounds that react with amino acids upon cooking to provide a browning effect. Unfortunately, while the browning agents discussed above can be used in meat analogue compositions to provide a browning effect to the compositions upon cooking, the inclusion of heat-stable colourants such as those discussed above in the meat analogue mean that the browned meat analogue product appears less brown when cooked despite the inclusion of a browning agent, since the heat stable colourants typically impart an undesirable reddish or similar colour to the cooked meat product.

The inventors of the present invention have appreciated that in meat analogue compositions known in the art, the browning agents and colourants used therein do not provide an effective raw meat colour to brown cooked meat colour transition upon cooking of the meat analogue compositions. A raw meat colour to cooked meat colour transition, such as a red colour to brown colour transition upon cooking is highly desirable since this is what occurs in real animal-derived meats upon cooking. It is highly desirable from a consumer perspective for meat analogue compositions to have a raw red meat colour upon purchase and to maintain this colour until the point of cooking where the meat analogue composition changes to a brown colour so that the meat analogue composition more closely resembles the behaviour of real meat.

The inventors of the present invention have thus appreciated that there remains a need in the art for an effective colour transition from raw to cooked upon cooking of meat analogue compositions.

Another objective of the present invention is to improve the tenderness of the cooked meat analogue composition, providing a better sensory experience for the consumer.

### SUMMARY OF THE INVENTION

The present invention is based upon the surprising finding that certain additives, when used in meat analogue compositions, can act as Maillard browning agents to provide a browning effect upon cooking of the meat analogue composition similar to that observed in real meat, whilst also effectively breaking down colourants present in the meat analogue composition upon cooking such as red colourants. As a result, the use of said additives means that an effective colour transition upon cooking can be provided for meat analogue compositions meaning that said compositions more closely resemble the colour and colour change upon cooking of real animal-derived meat products, for example from a red ‘raw’ colour to a brownish ‘cooked’ colour. Surprisingly, it has been found that the use of alkali ingredients such as basic salts in meat analogue compositions promote the Maillard reaction in the meat analogue compositions upon cooking to provide a browning effect whilst also causing the colourant present in the meat analogue composition to break down meaning that said colourant does not provide colour or at least provides less colour (i.e. less of a raw meat look) to the cooked meat analogue product. The ability of the alkali ingredients to both provide a Maillard browning effect whilst also degrading any colourants present in the meat analogue composition effectively imparts a synergistic optical browning effect to the meat analogue composition upon cooking. In this regard, whilst the alkali ingredients may be as effective a Maillard browning agent as other browning agents, the action of the alkali ingredients to simultaneously degrade the colourants results in the meat analogue composition of the invention appearing even more browned in comparison to when using alternative Maillard browning agents. In this regard, the alkali ingredients provide a synergistic improved optical browning effect.

It has also surprisingly been found by the inventors of the present invention that the use of one or more alkali ingredients in meat analogue compositions improves the tenderness of the meat analogue compositions when cooked, when compared to meat analogue compositions that do not comprise alkali ingredients.

The alkali ingredients used in the present invention may be added both on the surface of the meat analogue composition when formed into food products and/or mixed into the bulk matrix of the meat analogue composition. In both of these scenarios, increased tenderness of the cooked meat analogue composition and improved colour appearance of both the uncooked and the cooked meat analogue composition are provided.

According to a first aspect of the invention, there is provided a meat analogue composition comprising from 2.0% to 20.0% by weight of a fat composition; from 5.0% to 30.0% by weight of a non-animal protein; from 30.0% to 70.0% by weight of water; from 0.01% to 5% by weight of one or more colourants; and from 0.005% to 5% by weight of one or more alkali ingredients.

Preferably, the one or more alkali ingredients present in the meat analogue composition are encapsulated alkali ingredients. It has been found by the inventors that the inclusion of the alkali ingredients sometimes prematurely breaks down known colourants prior to cooking so that the red colour of the uncooked meat analogue compositions is lost or degraded merely by storage, and thus by the time the meat analogue compositions are cooked the raw colour has already been lost. In order to solve this problem, the inventors have surprisingly found that by encapsulating the alkali ingredients, the alkali ingredients are prevented from degrading the colourants until cooking of the product, meaning that the raw appearance of the meat analogue product can be maintained until the point of cooking at which point the colourants are broken down as the meat analogue product is simultaneously browned. Thus, it is preferable that the one or more alkali ingredients are encapsulated, although it will be understood that this feature is not essential.

The term encapsulated alkali ingredients as used herein is used to refer to the alkali ingredients being substantially prevented from interacting with the one or more colourants present in the meat analogue composition, and preferably completely prevented from interacting with the one or more colourants present in the meat analogue composition whilst the meat analogue composition is in uncooked form. Upon cooking or partial cooking of the meat analogue composition, the one or more encapsulated alkali ingredients are released from their encapsulation within the meat analogue composition such that they are able to interact with the one or more colourants present in the composition. Examples of encapsulation of the one or more alkali ingredients are discussed in further detail below and include encapsulation in a solid or substantially solid fat matrix, or encapsulation in a coating where the alkali ingredients are in the meat analogue composition in the form of coated particles. Additionally, combinations of such types of encapsulation may be used.

### Alkali Ingredients

Typically, the meat analogue composition comprises from 0.1% to 5% by weight of the one or more alkali ingredients. Preferably, the meat analogue composition comprises from 0.1% to 2.5% by weight of the one or more alkali ingredients. More preferably, the meat analogue composition comprises from 0.1% to 1% by weight of the one or more alkali ingredients. Alternatively, the meat analogue composition comprises from 0.005% to 1% by weight of the one or more alkali ingredients such as from 0.005% to 0.1% by weight of the one or more alkali ingredients. It will be appreciated that the amount of one or more alkali ingredients that is included in the meat analogue composition will be dependent upon the strength of the one or more alkali ingredients. Typically, stronger alkali ingredients will be included in the meat analogue composition in a lower amount whereas weaker alkali ingredients will be included in the meat analogue composition in higher amounts.

Any suitable alkali ingredient can be included in the meat analogue compositions. Typically, the one or more alkali ingredients comprise a food grade edible alkali ingredient. Typically, the one or more alkali ingredients comprise an alkali metal salt, an alkaline earth metal salt, an ammonium salt, an amine, or a combination thereof. Preferably, the one or more alkali ingredients comprise a hydroxide, carbonate, bicarbonate, chloride, gluconate, acetate or sulfide salt of a sodium, potassium, calcium, magnesium or ammonium cation. More preferably, the one or more alkali ingredients comprise sodium bicarbonate, magnesium bicarbonate, potassium bicarbonate, ammonium bicarbonate, sodium hydroxide, potassium hydroxide, calcium hydroxide, magnesium hydroxide, ammonium hydroxide, or any combination thereof.

By way of example, the one or more alkali ingredients may comprise sodium bicarbonate, magnesium bicarbonate, potassium bicarbonate, ammonium bicarbonate, or a combination thereof; and wherein the one or more alkali ingredients are present in the meat analogue composition in an amount of from 0.1% to 2.5% by weight, and more preferably from 0.1% to 1% by weight.

By way of further example, the one or more alkali ingredients may comprise sodium hydroxide, potassium hydroxide, calcium hydroxide, magnesium hydroxide, ammonium hydroxide, or any combination thereof; and wherein the one or more bases are present in the meat analogue composition in an amount of from 0.005% to 1% by weight, and preferably from 0.005% to 0.1% by weight.

As noted above, the one or more alkali ingredients may be encapsulated within a fat matrix. Preferably, the one or more alkali ingredients are encapsulated within a fat matrix of the fat composition. Where the one or more alkali ingredients are encapsulated within a fat matrix of the fat composition, the one or more alkali ingredients are typically present in the fat composition in an amount of from 0.005% to 40% by weight of the fat composition; preferably in an amount of from 1% to 20% and more preferably in an amount of 5% to 15% by weight of the fat composition. Most preferably, the one or more encapsulated alkali ingredients are present in the fat composition in an amount of from 5% to 10% by weight of the fat composition.

Such compositions may be prepared by methods such as dispersing the one or more alkali ingredients in a molten or semi-molten fat composition. After dispersion of the one or more alkali ingredients in the molten or semi-molten fat composition, the dispersions may be further processed such as crystallised in a crystallization unit such as a margarine processing unit.

Alternatively, or in addition, the one or more alkali ingredients may be encapsulated by a coating as described above. Typically, the coating comprises a water insoluble hydrophobic coating. This is preferable since meat analogue compositions typically contain a significant proportion of water. It is preferable that the coating does not breakdown in the presence of water so that the alkali ingredients remain encapsulated and prevented from interacting with any colourants present until cooking. Preferably, the coating is adapted to degrade at temperatures above 30° C., preferably 45° C., more preferably 60° C. and most preferably 75° C. This is also preferable so that the coating does not break down until cooking. As the temperature of the meat analogue composition increases, such as during cooking, the coating will break down meaning that the alkali ingredients are then able to interact with the colourants.

The coating may be any suitable coating but is typically a fat coating, a carbohydrate coating, a monoacylglyceride (MAG) coating, or a combination thereof. Preferably, the coating comprises a fat coating. More preferably, the fat coating comprises a fat with a melting point of from 40° C. to 80° C. Preferably, the fat is a non-animal derived fat. Any suitable fats known in the art that have the abovementioned properties may be used for the coating.

The one or more encapsulated alkali ingredients may comprise coated particles with an average particle size of less than 650 μm. The term particle size is used in reference to the size of a discrete particle comprising the alkali ingredient and coating. This is highly preferred since it enables a more effective homogenous distribution of the particles within the meat analogue composition which provides a more homogenous distribution of browning effect on surfaces of food products comprising the meat analogue composition and a more homogenous degradation of the one or more colourants in the meat analogue composition upon cooking. This is harder to achieve with larger sized coated particles. Thus, it is preferable that at least 99% of the coated particles are able to pass through a sieve with a mesh size of from 450 μm to 630 μm.

The one or more encapsulated alkali ingredients may comprise coated particles with a coating thickness of from preferably 25% to 50% of total particle thickness. More preferably, the one or more encapsulated alkali ingredients comprise coated particles with a coating thickness of from 30% to 45% of total particle thickness such as 30% or 40%. This is preferred since it is sufficiently thick to effectively encapsulate the alkali ingredients and prevent their interaction with the colourants until cooking, whilst also being sufficiently thin such that the coating is easily degraded upon cooking to enable the alkali ingredients to then interact with the colourants. The term coating thickness as used herein with reference to total particle thickness is used to refer to the total thickness of the coating on both sides of the particle (i.e. the sum of the coating thickness on both sides of the particle). The term total particle thickness is used to refer to the sum of the total thickness of the coating and the thickness of the alkali ingredients within the coated particle.

Coated alkali particles may be manufactured using techniques known in the art. Suitable coated alkali particles are commercially available.

In addition, the one or more alkali ingredients may be encapsulated by a coating as described above, before being further encapsulated in a fat matrix, such as the fat matrix of the fat composition. The coated alkali ingredients may be dispersed in a molten or semi-molten fat composition. Alternatively or in addition, the coated alkali ingredients are dispersed in a semi liquid crystallised fat composition. When adding coated alkali ingredients to a fat composition for further encapsulation, the fat composition should be at a temperature lower than the melting point of any fat present in the coating of the coated alkali ingredients.

### Colourants

The meat analogue composition comprises one or more colourants. Preferably, the one or more colourants are present in the meat analogue composition in an amount of from 0.5% to 2.5% by weight of the meat analogue composition.

Any suitable colourant may be used in the meat analogue compositions of the invention. Examples of suitable colourants that may be used include natural colourants; nature-identical colourants; synthetic colourants; colouring foodstuffs; or any combination thereof. Natural colourants are obtained from natural sources such as grasses, vegetables, fruit skins, roots and seeds. Nature identical colourants are the same molecules as natural colourants but are made synthetically instead of being extracted from naturally occurring materials. Examples of such colourants include flavonoids which are found in flowers, fruits and vegetables; indigoid found in beetroot; and carotenoids found in carrots, tomatoes, oranges and most plants. Synthetic colourants are colourant compounds that do not occur in nature and have been chemically synthesised. Examples of synthetic colourants include azo dyes such as amaranth; quinoline, xanthene, and triarylmethanes. A colouring foodstuff is a food ingredient that may also provide colourant functionality.

It is preferable that the one or more colourants maintain at least some degree of colouring of the meat analogue composition until the point of cooking. In other words, it is preferable that the one or more colourants do not substantially degrade and lose their colourant functionality during storage between manufacture of the meat analogue composition and cooking of the composition. More preferably, the one or more colourants fully maintain colouring of the meat analogue composition until the point of cooking.

Preferably, the one or more colourants used in meat analogue compositions of the invention comprise anthocyanins, betanins, carotenoids, lycopine, carminic acid, or any combination thereof. More preferably, the one or more colourants comprise one or more betanins. Most preferably, the one or more colourants comprise red beet.

More specifically, the one or more colourants used in meat analogue compositions of the invention comprise colourant made from beetroot and carrot (e.g. Exberry Shade Fiesta Pink), colourant made from paprika and carrot (e.g. Exberry Shade Brilliant orange), colourant made from spirulina (e.g. Exberry Shade Bleu-HP), or a combination thereof.

It will be appreciated by the skilled person that the specific colourants and colourant combinations used and the specific amounts of each colourant will vary depending on the desired colour of a particular meat analogue composition, and other specific features of the meat analogue composition in question such as what fat is used in the composition.

### Fats for Use in Meat Analogue Compositions

Any suitable fat composition for use in meat analogue compositions may be used in meat analogue compositions of the invention.

Preferably, the fat composition is present in the meat analogue composition in an amount of from 7.5% to 20% by weight of the meat analogue composition.

Typically, the fat composition comprises a non-animal derived fat such as a vegetable oil. This is desirable so that the meat analogue composition qualifies as a food product suitable for consumption by vegetarians and vegans. It is more preferred that vegetable oils with higher melting points are used than lower melting point vegetable oils. This is because the fats used in real meat burgers are animal fats which typically have higher melting points and higher saturated fatty acid contents. By using a high melting point vegetable oil, the functional and sensory properties of animal fat found in meat are more effectively mimicked. Examples of higher melting point vegetable fats include palm oil, shea butter and coconut oil. However, certain lower melting point vegetable oils such as sunflower oil may also be used. Preferably, the fat composition comprises coconut oil, palm oil, sunflower oil, shea butter, or a combination thereof. More preferably, the fat composition comprises palm oil, coconut oil, or a combination thereof. Most preferably, the fat composition comprises coconut oil.

The term “fat” as used herein refers to glyceride fats and oils containing fatty acid acyl groups and does not imply any particular melting point. The term “oil” is used synonymously with “fat” herein.

The term “fatty acid”, as used herein, refers to straight chain saturated or unsaturated (including mono- and poly unsaturated) carboxylic acids having 8 to 24 carbon atoms. A fatty acid having x carbon atoms and y double bonds may be denoted Cx:y. For example, palmitic acid may be denoted C16:0, oleic acid may be denoted C18:1. Percentages of fatty acids in compositions referred to herein include acyl groups in tri-, di- and mono-glycerides present in the glycerides and are based on the total weight of C8 to C24 fatty acids. The fatty acid profile (i.e. composition) may be determined, for example, by fatty acid methyl ester analysis (FAME) using gas chromatography according to ISO 12966-2 and ISO 12966.4.

Triglyceride content may be determined for example based on molecular weight differences (Carbon Number (CN)) by AOCS Ce 5-86. The notation triglyceride CNxx denotes triglycerides having xx carbon atoms in the fatty acyl groups, e.g. CN54 includes tristearin. Amounts of triglycerides specified with each carbon number (CN) as is customary terminology in the art are percentages by weight based on total triglycerides of CN26 to CN62 present in the fat composition.

Preferably, the fat composition contains a substantially major portion of fat with very little water (i.e. the fat composition consists essentially of fat molecules). However, the fat composition may contain water and be present in the form of an emulsion such as an oil-in-water emulsion or a water-in-oil emulsion, typically with a suitable emulsifier. Where this is the case, the weight percentage ranges provided above for the amount that the fat composition is present in the meat analogue composition refers to only fat molecules present in the fat composition, and not any water present in the composition. Similarly, the weight percentages given above for the amount of water present in the meat analogue composition refers to both water added in its own right during manufacture of the meat analogue composition, and also to any water present in other components of the meat analogue composition (such as water present in an emulsified fat composition), or water bound to any protein, as discussed in further detail below. It has also been found possible to use in meat analogue compositions of the invention certain fat compositions known for use in other food applications such as bakery products but not currently known for use in meat analogue products. Surprisingly, it has been found that these fat compositions have properties suitable for use in meat analogue compositions, and may also provide various advantages over the use of fats known for use in meat analogue compositions such as coconut oil. It has also surprisingly been found that the fat compositions discussed in further detail below are particularly good at encapsulating the one or more alkali ingredients and preventing said ingredients from interacting with the one or more colourants until the point of cooking.

By way of example, the fat composition may comprise from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition. Preferably, the fat composition comprises from 20% to 70% by weight of saturated fatty acids, for example 20 to 65% by weight of saturated fatty acids, and more preferably from 20% to 60% by weight of saturated fatty acids. The fat composition may also comprise 65% to 85% by weight of saturated fatty acids. Typically, the fat composition comprises from 2 to 12 percent by weight of St2M triglycerides, preferably from 5 to 12 percent by weight of St2M triglycerides. A St2M triglyceride is a triglyceride molecule comprising two stearic acid residues and one residue of either lauric acid or myristic acid. Typically, the fat composition comprises from 5 to 35 percent by weight of CN46 and CN48 triglycerides, preferably from 10 to 30 percent by weight of CN46 and CN48 triglycerides. The abbreviation CN stands for the total carbon number of the fatty acid moieties present in the triglyceride molecule. For example, a triglyceride comprising two stearic acid residues and one lauric acid residue would have a total carbon number of 48. The fat composition preferably is a non-hydrogenated fat composition.

Typically, the fat composition comprises 20% by weight or less, and preferably 10% by weight or less of palmitic acid (C16:0). Typically, the fat composition has a weight ratio of stearic acid (C18:0) to palmitic acid (C16:0) of from 1:1 to 12:1. Typically, the fat composition has a weight ratio of lauric acid (C12:0) to stearic acid (C18:0) of from 1:4 to 4:1. Preferably, the fat composition comprises from 10% to 25% by weight lauric acid (C12:0); and/or from 15% to 45% by weight stearic acid (C18:0). More preferably, the fat composition comprises from 10% to 25% by weight lauric acid (C12:0); and from 15% to 45% by weight stearic acid (C18:0).

Typically, the fat composition, has one or more of the following properties.
(i) the fat composition has a solid fat content (SFC) N40 of less than 10, measured on unstabilised fat according to ISO 8292-1, preferably from 1 to 9, and more preferably from 2 to 8;
(ii) the fat composition has a solid fat content (SFC) N20 of from 35 to 60, preferably from 25 to 56, more preferably from 20 to 40, as measured on the unstabilised fat according to ISO 8292-1; and
(iii) the fat composition has a solid fat content (SFC) N30 of from 5 to 35, preferably from 8 to 32; more preferably from 8 to 30, as measured on the unstabilised fat according to ISO 8292-1.

Preferably, the fat composition has all three of the above properties.

The fat composition as described above may be made from naturally occurring or synthetic fats, fractions of naturally occurring or synthetic fats, or mixtures thereof, that satisfy the requirements for fatty acids and triglyceride compositions discussed above. Preferably, the fat composition is derived from a blend of naturally occurring fats.

Preferably, the fat composition as described above comprises an interesterified fat, and more preferably wherein the fat composition comprises an interesterified fat blend. The interesterified fat or interesterified fat blend may be produced by chemical interesterification, enzymatic interesterification, or a combination thereof.

The interesterified fat or interesterified fat blend may be produced by an enzymatic interesterification reaction which does not reach an equilibrium product distribution. It has been found that this provides a fat composition product with optimum properties for use in a meat analogue composition, such as the properties discussed above.

Processes for the preparation of the fat compositions such as the interesterification reactions discussed above are known in the art, and are discussed in, for example, Dijkstra, A. J. Interesterification. In: The Lipids Handbook 3rd Edition, pages 285-300 (F. D. Gunstone, J. L. Harwood, and A. J. Dijkstra (eds.), Taylor & Francis Group LLC, Boca Raton, FL) (2007).

Preferably, the fat composition as described above comprises an interesterified fat blend comprising a vegetable oil high in stearic acid and a vegetable oil high in lauric acid. Preferably, the vegetable oil high in stearic acid is also high in monounsaturated fatty acids such as oleic acids. Accordingly, in typical examples, the fat composition comprises an interesterified fat blend comprising at least one fat selected from shea butter, shea stearin, shea olein, cocoa butter, cocoa stearin, cocoa olein, allanblackia fat, kokum fat, mango kernel fat, sal fat, illipe butter, and mixtures thereof; and at least one oil selected from coconut oil, coconut oil stearin, coconut oil olein, palm kernel oil, palm kernel olein, palm kernel stearin, babassu oil, and mixtures thereof.

Preferably, the fat composition as described above comprises an interesterified blend of shea butter and coconut oil or an interesterified blend of shea stearin and coconut oil. For example, the fat composition may comprise an interesterified blend of from 20% to 80% by weight of shea butter and from 20% to 80% by weight of coconut oil. Alternatively, or in addition, the fat composition may comprise an interesterified blend of from 20% to 80% by weight of shea stearin and from 20% to 80% by weight of coconut oil.

In a highly preferable example, the fat composition as described above comprises a blend of (i) from 20% to 80% by weight of an interesterified blend of from 20% to 80% by weight of shea butter and/or shea stearin and from 20% to 80% by weight of coconut oil; and (ii) from 20% to 80% by weight of sunflower oil.

Alternatively, the fat composition may comprise an interesterified blend of vegetable oil and fully hydrogenated vegetable oil. For such a blend, the fat composition may comprise up to 100% by weight of the fat composition of the interesterified blend of vegetable oil and fully hydrogenated vegetable oil, such as up to 80%, 70%, 60%, 50%, 40% or 30% by weight. The fat composition may comprise (a) from 5% to 95% by weight of the fat composition of the interesterified blend of vegetable oil and fully hydrogenated vegetable oil and (b) from 5% to 95% by weight of the fat composition of blending vegetable oil. For example, the fat composition may comprise (a) from 10% to 90% by weight of the fat composition of the interesterified blend of vegetable oil and fully hydrogenated vegetable oil and (b) from 10% to 90% by weight of the fat composition of blending vegetable oil. Preferably, the fat composition comprises (a) from 20% to 80% by weight of the fat composition of the interesterified blend of vegetable oil and fully hydrogenated vegetable oil and (b) from 20% to 80% by weight of the fat composition of blending vegetable oil. More preferably, the fat composition comprises (a) from 50% to 80% by weight of the fat composition of the interesterified blend of vegetable oil and fully hydrogenated vegetable oil and (b) from 20% to 50% by weight of the fat composition of blending vegetable oil. Most preferably, the fat composition comprises (a) from 60% to 80% by weight of the fat composition of the interesterified blend of vegetable oil and fully hydrogenated vegetable oil and (b) from 20% to 40% by weight of the fat composition of blending vegetable oil.

Typically, the interesterified blend is an interesterified blend of from 20% to 60% by weight of vegetable oil and from 40% to 80% by weight of fully hydrogenated vegetable oil. Preferably, the interesterified blend is an interesterified blend of from 40% to 60% by weight of vegetable oil and from 40% to 60% by weight of fully hydrogenated vegetable oil. More preferably, the interesterified blend is an interesterified blend of from 45% to 55% by weight of vegetable oil and from 45% to 55% by weight of fully hydrogenated vegetable oil.

In the context of the present application, the term “hardstock” is used herein to refer to the interesterified blend component of the fat composition (i.e. component (a) when a blending vegetable oil is included).

Typically, the interesterified blend is an interesterified blend of liquid vegetable oil and fully hydrogenated vegetable oil. Preferably, the interesterified blend is an interesterified blend of non-tropical vegetable oil and fully hydrogenated non-tropical vegetable oil. Non-tropical vegetable oils are those that can be grown in non-tropical regions of the world such as North America and Europe.

The interesterified blend may be an interesterified blend of (i) fully hydrogenated vegetable oil and (ii) vegetable oil, each vegetable oil being selected from rapeseed oil, high oleic rapeseed oil, high erucic acid rapeseed oil, soybean oil, sunflower oil, high oleic sunflower oil, linseed oil, olive oil, corn oil, cottonseed oil, carinata oil, groundnut oil, safflower oil, high oleic safflower oil, peanut oil, rice oil, camelina oil, or any combination thereof, although it will be understood that similar vegetable oils may also be used.

Preferably, the interesterified blend is an interesterified blend of (i) fully hydrogenated vegetable oil and (ii) vegetable oil, each vegetable oil selected from rapeseed oil, high oleic rapeseed oil, high erucic acid rapeseed oil, or a combination thereof.

The term “fully hydrogenated vegetable oil” as used herein is used to refer to a vegetable oil that has undergone hydrogenation so as to convert its unsaturated fatty acid residues into saturated fatty acid residues. Suitable process conditions and methods for hydrogenating vegetable oil are known in the art. Any suitable fat hydrogenation process known in the art can be used to produce the fully hydrogenated vegetable oils of the present invention. For example, hydrogenation processes discussed in EP2196094 can be used. The term fully hydrogenated as used herein is used to distinguish the hydrogenated vegetable oils for use in producing the hardstock from partially hydrogenated vegetable oils which typically contain a significant quantity of trans fatty acid residues. In full hydrogenation, the hydrogenation process is allowed to continue to such an extent that all or substantially all of the unsaturated fatty acid residues present in the molecule are converted to saturated fatty acid residues. Accordingly, the fully hydrogenated vegetable oil may comprise less than 5% by weight of trans fatty acids, more preferably less than 2% by weight of trans fatty acids and most preferably less than 1% by weight of trans fatty acids, wherein said percentages of fatty acid residues refers to fatty acids bound as acyl groups in glycerides in the fully hydrogenated vegetable oil and being based on the total weight of C4 to C24 fatty acid residues bound as acyl groups present in the fully hydrogenated vegetable oil.

In addition, the hardstock may be derived from interesterification of a first vegetable oil and a fully hydrogenated vegetable oil that is itself derived from the first vegetable oil, although it will be understood that this is not essential. By way of example, the interesterified blend may be an interesterified blend of (i) fully hydrogenated rapeseed oil and (ii) rapeseed oil.

In another example, the fully hydrogenated vegetable oil may comprise high erucic acid rapeseed oil, or other fully hydrogenated fats with a mixed fatty acid chain length. More preferably, the interesterified blend is an interesterified blend of (i) fully hydrogenated vegetable oil; (ii) fully hydrogenated high erucic acid rapeseed oil; and (iii) vegetable oil such as rapeseed oil or high oleic rapeseed oil. Most preferably, the interesterified blend is an interesterified blend of (i) from 40% to 60% by weight of vegetable oil such as rapeseed oil; (ii) from 5% to 15% by weight of fully hydrogenated high erucic acid rapeseed oil; and (iii) from 30% to 50% by weight of fully hydrogenated rapeseed oil. Other fully hydrogenated fats with a mixed fatty acid chain length include carinata oil.

Typically, the interesterified blend comprises less than 55% by weight of saturated fatty acid residues, wherein said percentages of fatty acid residues refers to fatty acids bound as acyl groups in glycerides in the interesterified blend and being based on the total weight of C4 to C24 fatty acid residues bound as acyl groups present in the interesterified blend.

Typically, the interesterified blend comprises stearic acid residues in amount of from 40% to 60% and/or palmitic residues in an amount of 2.5% to 7.5%, wherein said percentages of fatty acid residues refers to fatty acids bound as acyl groups in glycerides in the interesterified blend and being based on the total weight of C4 to C24 fatty acid residues bound as acyl groups present in the interesterified blend.

Preferably, the fat composition as described above comprises from 45% to 55% by weight of saturated fatty acid residues; from 30% to 40% of monounsaturated fatty acid residues; from 5% to 15% of polyunsaturated fatty acid residues; and/or less than 1% of trans unsaturated fatty acid residues; wherein said percentages of fatty acid residues refers to fatty acids bound as acyl groups in glycerides in the interesterified blend and being based on the total weight of C4 to C24 fatty acid residues bound as acyl groups present in the interesterified blend.

Preferably, the fat composition as described above comprises from 40% to 50% by weight of C18:0; from 30% to 40% by weight of C18:1; from 5% to 12% of C18:2; from 1% to 6% of C18:3; and/or from 2.5% to 7.5% of C16:0; wherein said percentages of fatty acid residues refers to fatty acids bound as acyl groups in glycerides in the interesterified blend and being based on the total weight of C4 to C24 fatty acid residues bound as acyl groups present in the interesterified blend.

The interesterified blend as described above is produced by interesterification of the fully hydrogenated vegetable oil and liquid vegetable oil. Typically, the interesterified blend has been produced by chemical interesterification, enzymatic interesterification, or a combination thereof. Any suitable interesterification process known in the art can be used to produce the interesterified blend. Suitable processes conditions for interesterification are known. For example, the interesterification process conditions discussed in EP2196094 can be used.

The fat composition as described above also comprises blending vegetable oil component (b) which is mixed with the hardstock composition. Blending vegetable oil component (b) can be any suitable vegetable oil. Typically, blending vegetable oil component (b) is a liquid vegetable oil. Typically, blending vegetable oil component (b) is a non-tropical vegetable oil. Preferably, the blending vegetable oil of (b) comprises rapeseed oil, high oleic rapeseed oil, soybean oil, sunflower oil, high oleic sunflower oil, linseed oil, olive oil, corn oil, cottonseed oil, groundnut oil, safflower oil, high oleic safflower oil, peanut oil, rice oil, camelina oil, or any combination thereof.

Additionally or alternatively, the fat composition may comprise a blend of liquid vegetable oil and a fully hydrogenated liquid vegetable oil; or a blend of a liquid vegetable oil and a vegetable oil stearin. Preferably, the liquid vegetable oil comprises rapeseed oil.

Preferably, the fully hydrogenated liquid vegetable oil comprises fully hydrogenated rapeseed oil. Preferably, the vegetable oil stearin comprises palm stearin. Typically, in such fat blends, the liquid vegetable oil is present in an amount of from 90% to 99% by weight of the blend; and the fully hydrogenated liquid vegetable oil or vegetable oil stearin is present in an amount of from 1% to 10% by weight of the fat blend. Such oil blends are typically semi liquid crystallised fat blends. Advantages associated with the use of such fat blends is that they tend to have lower saturated fatty acid contents compared to other fats used in meat analogue compositions.

In a preferred instance, the fat compositions comprise (i) a blend of liquid vegetable oil and a fully hydrogenated liquid vegetable oil and also (ii) a fat composition comprising from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition. Preferably, component (ii) comprises an interesterified blend of coconut oil and shea butter or coconut oil and shea stearin, such as those interesterified blends described above. The fat composition may further comprise a liquid vegetable oil such as rapeseed oil in addition to components (i) and (ii) discussed above.

In other instances such as described above, the fat composition comprises (i) a blend of a liquid vegetable oil and a vegetable oil stearin; and (ii) a fat composition comprising from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition. The fat composition may further comprise a liquid vegetable oil such as rapeseed oil in addition to components (i) and (ii) discussed above.

Where the fat compositions comprise a (i) blend of liquid vegetable oil and a fully hydrogenated liquid vegetable oil; or a blend of a liquid vegetable oil and a vegetable oil stearin; and (ii) a liquid vegetable oil, components (i) and (ii) are typically present in a weight ratio of from 3:1 to 1:1.

Where the fat compositions comprise a (i) blend of liquid vegetable oil and a fully hydrogenated liquid vegetable oil; or a blend of a liquid vegetable oil and a vegetable oil stearin; and (ii) a fat composition comprising from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition; components (i) and (ii) are typically present in a weight ratio of from 1:1 to 1:3.

### Other Components of the Meat Analogue Compositions

The meat analogue compositions of the invention may comprise one or more reducing sugars. Preferably, the one or more reducing sugars comprise one or more monosaccharide sugars. More preferably, the one or more reducing sugars comprise dextrose.

Typically, the one or more reducing sugars are present in an amount of from 0.1% to 5% by weight of the meat analogue composition; and preferably from 0.5% to 2% by weight of the meat analogue composition.

Surprisingly, it has been found that a further synergistic effect occurs in meat analogue compositions when one or more alkali ingredients and one or more reducing sugars are included in the meat analogue compositions. On cooking such as frying, a heterogeneous browning effect is observed on the surface of the food product comprising the meat analogue composition. This heterogeneous browning effect more closely mimics the visual effect of browned real meat products arising from the heterogeneous fat and protein distribution in the surface of real meat products. Surprisingly, it has been found that this effect is imparted to meat analogue food products when both alkali ingredients and reducing sugars are used. This is in contrast to meat analogue products that brown more homogenously when cooked and do not have the heterogenous browned appearance of real meat. Whilst alkali ingredients used alone contribute towards a browning effect of the meat analogue composition, this browning effect is the more homogeneous browning effect more commonly observed in browned cooked meat analogue products. In contrast, when both of these browning agents are included in the meat analogue composition, a surprising heterogeneous browning effect is observed. Without being limited by theory, it is believed that the synergistic optical effect of improved browning provided by the alkali ingredients simultaneously breaking down the colourants whilst providing a Maillard browning effect is further enhanced by the presence of reducing sugar to provide the heterogenous browning effect described above.

The term heterogeneous browning effect as used herein is used to refer to a browned surface of a cooked or partially cooked meat analogue product where different parts of the surface are browned to different extents. This difference in extent of browning between different regions of the surface gives the browned product surface a less uniform and more heterogenous appearance. In contrast, the term browned homogeneous surface is used to refer to a browned surface of a food product where there is substantially little difference in the extent to which the food product is browned across its surface.

The meat compositions of the invention comprise one or more non-animal proteins, such as one or more proteins derived from fungi, plants, or a combination thereof.

Typically, the non-animal protein comprises plant protein. Preferably, the plant protein is selected from algae protein, black bean protein, canola wheat protein, chickpea protein, fava protein, lentil protein, lupin bean protein, mung bean protein, oat protein, pea protein, potato protein, rice protein, soy protein, sunflower seed protein, wheat protein, white bean protein, and protein isolates or concentrates thereof. Alternatively or additionally, the non-animal protein may also comprise seitan, rice protein, mushroom protein, legume protein, tempeh, yam flour, tofu, mycoprotein, peanut flour, yuba, or a combination thereof.

More preferably, the non-animal protein comprises texturized vegetable proteins, preferably wherein the texturized vegetable proteins comprise texturized pea proteins, texturized fava proteins, texturized soy proteins, texturized wheat proteins or a combination thereof. Preferably, the texturized vegetable protein is present in the meat analogue composition in an amount of from 10% to 20% by weight of the meat analogue composition.

The non-animal protein is present in the meat analogue composition in an amount of from 5% to 30% by weight of the meat analogue composition. Preferably, the non-animal protein is present in the meat analogue composition in an amount of from 10% to 30% by weight of the meat analogue composition, and more preferably from 15% to 30% by weight of the meat analogue composition.

Plant protein is a source of protein which is obtained or derived from plants. The plant protein may be any suitable plant protein and may comprise a mixture of plant proteins and/or may include protein isolates or concentrates. Examples of suitable plant proteins include those discussed above. As discussed above, preferably, the plant protein comprises textured vegetable proteins (TVP). TVPs are extruded proteins, which may be either dry or moist (i.e. hydrated). TVP is widely available and may be made from plant sources as mentioned above, such as soy flour or concentrate. In dry form, TVP can comprise up to about 70 wt. % of protein, typically about 60 to 70 wt. % of protein, and when hydrated comprises typically about 10 to 20 wt. % of protein. Typically, when hydrated TVPs can contain up to 3 to 4 times their dry weight in water. As discussed above, the weight percentage ranges referred to above for water present in the meat analogue compositions include both water added in its own right and water present in other components of the meat analogue composition such as in textured vegetable proteins or emulsified with fat. Similarly, the weight percentage ranges given above for the amount of non-animal protein present in the meat analogue composition refer to dry weight of protein, and do not include water bound to the non-animal protein such as in textured vegetable protein.

The plant protein used in the preparation of the meat-analogue composition may be either dry (also referred to as ‘dry phase’ herein) or moist. Thus, the plant protein may be included in a dry mix of ingredients, which may include additional ingredients intended for inclusion in the meat-analogue composition, such as carbohydrates, fibre and/or hydrocolloids, in addition to protein. If the plant protein is dry, it may be hydrated prior to and/or during the formation of the meat-analogue composition. The term ‘dry’ used in relation to the plant protein and ‘dry phase’ used herein, is intended to mean that the phase comprising plant protein comprises less than 5 wt. % water, preferably less than 2 wt. % water, more preferably less than 1 wt. % water, even more preferably that it is substantially free from water. In other examples, the aw of the dry phase is 0.90 or lower, more preferably below 0.80. The dry phase comprising plant protein is typically provided in a substantially dehydrated state to reduce microbial growth as far as possible so as to extend shelf life.

The meat-analogue composition comprises water, which may be added as a separate component to the composition, or derive from other components of the composition as discussed above. The amount of water is not particularly limited and, as the skilled person will appreciate, will vary depending on the intended consistency of the meat-analogue composition. Reference to ‘water’ herein is intended to include drinking water, demineralized water or distilled water, unless specifically indicated. As the skilled person will appreciate, deionized water is also a sub-class of demineralized water. Typically, the water is present in the meat analogue composition in an amount of from 30.0% to 70.0% by weight of the meat analogue composition, such as from 40.0% to 60.0% by weight.

The meat analogue composition typically comprises one or more additional ingredients. Whilst these one or more additional ingredients may be preferable to include in the meat analogue compositions, it will be understood that the inclusion of the one or more additional ingredients is not essential.

The meat analogue composition preferably further comprises a stabilizer blend. Typically, the stabilizer blend is present in an amount of from 2.5% to 20% by weight of the meat analogue composition. Preferably, the stabilizer blend is present in the meat analogue composition in an amount of from 5% to 10% by weight of the meat analogue composition. Typically, the stabilizer blend comprises vegetable derived protein, vegetable fibre and/or a polysaccharide. Preferably, the vegetable derived protein comprises pea protein, the vegetable fibre comprises pea fibre, and/or the polysaccharide comprises methylcellulose. Most preferably, the stabiliser blend comprises vegetable derived protein comprising pea protein, vegetable fibre comprising pea fibre, and polysaccharide comprising methylcellulose.

The meat analogue composition may comprise one or more flavouring additives. Preferably, the one or more flavouring additives are present in an amount of from 0.5% to 2% by weight of the meat analogue composition. Suitable flavouring additives known in the art may be used in the meat analogue compositions.

The meat analogue composition may further comprise one or more of: i) polysaccharides and/or modified polysaccharides, preferably selected from methylcellulose, hydroxypropyl methylcellulose, carboxymethyl cellulose, maltodextrin, carrageenan and salts thereof, alginic acid and salts thereof, agar, agarose, agaropectin, pectin and alginate; ii) hydrocolloids; and iii) gums, preferably selected from xanthan gum, guar gum, locust bean gum, gellan gum, gum arabic, vegetable gum, tara gum, tragacanth gum, konjac gum, fenugreek gum, and gum karaya.

Examples of other additives that may be included in the meat analogue compositions include an ionic or non-ionic emulsifier, a polyhydroxy compound, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, starch, salt, spices, fibre, flavour components, colourants, thickening and gelling agents, egg powder, enzymes, gluten, vitamins, preservatives, sweeteners, oxidising agents, reducing agents, anti-oxidants, acidity regulators, or combinations thereof.

Amino acids are a preferred additive for the meat-analogue compositions of the invention, since these are also known to contribute to the Maillard reaction and also aid in providing a browning effect.

Another particularly preferred additive for inclusion in meat analogue compositions of the invention are one or more acidity regulators. Any suitable acidity regulator may be used. Preferably, the one or more acidity regulators comprise a food grade organic acid such as citric acid. The one or more acidity regulators are preferably present in the meat analogue composition in an amount of from 0.1% to 2%, such as 0.2% to 1%, by weight of the meat analogue composition.

The one or more acidity regulators are typically included in the meat analogue composition to provide a desired pH of the uncooked meat analogue composition. Preferably, the pH of the meat analogue composition is greater than 5 when uncooked. More preferably, the pH of the meat analogue composition is from 5 to 9 when uncooked. Most preferably, the pH of the meat analogue composition is from 5.1 to 8.7 when uncooked.

Preferably, the meat analogue is suitable for consumption by vegetarians and vegans. Accordingly, the meat analogue composition may be substantially free of animal protein, and more preferably, the meat analogue composition is free of animal protein.

Preferably, the meat analogue composition is substantially free of animal-derived products, and more preferably, the meat analogue composition is free of animal-derived products.

However, alternatively, the meat analogue compositions may comprise animal-derived products such as animal derived proteins or fats. Accordingly, the meat analogue composition may further comprise one or more animal-derived products such as animal oils, marine oils, animal-derived proteins, animal-derived polysaccharides, or any combination thereof. The one or more animal-derived products may comprise animal milk proteins, animal milk fats, or a combination thereof. Thus, the meat analogue compositions may be suitable for consumption by vegetarians on the basis that they comprise non-animal protein and proteins or fats derived from animal milk. These meat analogue compositions are suitable for consumption by vegetarians since they do not include fats or proteins derived from meat. However, it will of course be understood that such meat analogue compositions are not suitable for consumption by vegans.

Where the meat analogue compositions comprise one or more animal-derived products, the one or more animal-derived products are typically present in the meat analogue composition in an amount of from 1% to 20% by weight of the meat analogue composition, such as from 1% to 10% by weight of the meat analogue composition.

### Food Products

According to a second aspect of the invention, there is provided a food product comprising a meat analogue composition of the invention. The food product may be an uncooked food product, a cooked food product, or a partially cooked food product.

Typically, the food product is a vegetarian or vegan meat substitute food product. Preferably, the vegetarian or vegan meat substitute food product is a burger, sausage, meat ball, nugget, patty, mince product, meatloaf, or other product intended to mimic conventional meat-based food products.

Where the food product is a cooked food product or a partially cooked food product, the food product typically has a pH of from 6 to 9; preferably from 7 to 9; and more preferably from 7 to 8.

Where the food product is a cooked food product or a partially cooked food product, the food product preferably has a pH greater than the pH of the food product when uncooked. This is desirable so as to prevent the premature breakdown of the one or more colourants by alkali ingredients prior to cooking of the food product. Once the food product is cooked or partially cooked, the heat from the cooking causes the one or more alkali ingredients to be released from their encapsulation (if an encapsulation is used) and this increases the pH of the meat analogue composition. The release of the one or more alkali ingredients from their encapsulation into the matrix of the meat analogue composition on cooking causes the alkali ingredients to act as a browning agent in the Maillard reaction causing the meat analogue product to be browned. Additionally, the one or more alkali ingredients interact with the one or more colourants causing the colourants to be broken down and for the red colour of the meat analogue composition to be degraded. If the one or more alkali ingredients are encapsulated, it is preferred that the change in pH upon cooking is as large as possible.

The properties of the meat-analogue composition or food products prepared using the composition may be measured by any suitable means. Properties of interest may include juiciness (and/or dryness), hardness, adhesiveness, springiness, cohesiveness, gumminess, chewiness and resilience. Such means include taste testers, which can provide feedback on properties of the composition or food product such as juiciness (or dryness), texture, chewiness and hardness. Typically multiple testers will be asked to mark one or more properties of the composition or food product, such as on a scale from 1 to 5. If multiple testers are asked, an average of the results can be taken to observe the general impression of the food product.

Properties of the composition or food product may also be measured using specialised equipment. For example, texture profile analysis (TPA) is a technique used to characterize textural attributes of solid and semisolid materials and may be used to determine the hardness, adhesiveness, springiness, cohesiveness, gumminess, chewiness and resilience. Gumminess is defined as the product of hardness x cohesiveness. Chewiness is defined as the product of gumminess x springiness (hardness x cohesiveness x springiness). In this technique, the test material may be compressed two times in a reciprocating motion, mimicking the chewing movement in the mouth, producing a Force versus Time (and/or distance) graph, from which the above information can be obtained. TPA and the classification of textural characteristics is described further in Bourne M. C., Food Technol., 1978, 32 (7), 62-66 and Trinh T. and Glasgow S., ‘On the texture profile analysis test’, Conference Paper, Conference: Chemeca 2012, Wellington, New Zealand, and may be performed as described therein.

The Force versus Time (and/or distance) graph typically includes two peaks in force, corresponding to the two compressions, separated by a trough. Force may be measured in gravitational force equivalent (g-force, g) or Newtons (N).

Hardness (g or N) is defined as the maximum peak force experienced during the first compression cycle.

Adhesiveness is defined as the negative force area for the first bite, i.e. the area of the graph between the two peaks in force which is at or below a force of 0 g or N. This represents the work required to overcome the attractive forces between the surface of a food and the surface of other materials with which the food comes into contact, i.e. the total force necessary to pull the compression plunger away from the sample. For materials with a high adhesiveness and low cohesiveness, when tested, part of the sample is likely to adhere to the probe on the upward stroke. Lifting of the sample from the base of the testing platform should, if possible, be avoided as the weight of the sample on the probe would become part of the adhesiveness value. In certain cases, gluing of the sample to the base of a disposable platform has been advised but is not applicable for all samples.

Springiness, also known as elasticity, is related to the height that the food recovers during the time that elapses between the end of a first compression and the start of a second compression. During the first compression, the time from the beginning of the compression at force=0 g or N to the first peak in force is measured (referred to as ‘Cycle 1 Duration’). During the second cycle, the time from the beginning of the second compression at force=0 g or N to the second peak in force is measured (referred to as ‘Cycle 2 Duration’). Springiness is calculated as the ratio of these values, i.e. ‘Cycle 2 Duration’/‘Cycle 1 Duration’.

Cohesiveness is defined as the ratio of the positive force area, i.e. the area under the curve above a force of 0 g or N, during the second compression to that during the first compression. Cohesiveness may be measured as the rate at which the material disintegrates under mechanical action. Tensile strength is a manifestation of cohesiveness. If adhesiveness is low compared with cohesiveness then the probe is likely to remain clean as the product has the ability to hold together. Cohesiveness is usually tested in terms of the secondary parameters brittleness, chewiness and gumminess.

Gumminess is defined as the product of hardness x cohesiveness and is a characteristic of semisolid foods with a low degree of hardness and a high degree of cohesiveness.

Chewiness is defined as the product of gumminess x springiness (which equals hardness x cohesiveness x springiness) and is therefore influenced by the change of any one of these parameters.

Resilience is a measurement of how the sample recovers from deformation both in terms of speed and forces derived. It is taken as the ratio of areas from the first probe reversal point, i.e. the point of maximum force, to the crossing of the x-axis, i.e. at 0 g or N, and the area produced from the first compression cycle between the start of compression and the point of maximum force. In order to obtain a meaningful value of this parameter, a relatively slow test speed should be selected that allows the sample to recover, if the sample possesses this property.

### Uses of Meat Analogue Compositions and Food Products

According to a third aspect of the invention, there is provided the use of one or more alkali ingredients as a browning agent in a meat analogue composition, wherein the meat analogue composition comprises from 2.0% to 20.0% by weight of a fat composition; from 5.0% to 30.0% by weight of a non-animal protein; from 30.0% to 70.0% by weight of water; from 0.01% to 5% by weight of one or more colourants; and from 0.005% to 5% by weight of the one or more alkali ingredients.

According to a fourth aspect of the invention, there is provided the use of one or more alkali ingredients in a meat analogue composition to improve the tenderness of the meat analogue composition, wherein the meat analogue composition comprises from 2.0% to 20.0% by weight of a fat composition; from 5.0% to 30.0% by weight of a non-animal protein; from 30.0% to 70.0% by weight of water; from 0.01% to 5% by weight of one or more colourants; and from 0.005% to 5% by weight of the one or more alkali ingredients.

Preferably, the use of the third and fourth aspects of the invention further comprises using the meat analogue composition in a food product.

Preferably, in the use of the third and fourth aspects of the invention, the meat analogue composition, fat composition and/or food product are as described above.

Preferably, the use of the third and fourth aspects of the invention comprises using the one or more alkali ingredients to achieve a raw meat colour to a cooked meat colour transition of the meat analogue composition upon cooking, such as a red colour to brown colour transition.

Where the one or more alkali ingredients are encapsulated within a fat matrix, such as within a fat matrix of the fat composition, the uses of the third and fourth aspects of the invention may further comprise using the fat matrix to inhibit or prevent interaction of the one or more encapsulated alkali ingredients and one or more colourants in the meat analogue composition prior to cooking of the meat analogue composition.

Where the one or more alkali ingredients are encapsulated by a coating, the use of the third and fourth aspects of the invention may further comprise using the coating to inhibit or prevent interaction of the one or more encapsulated alkali ingredients and one or more colourants in the meat analogue composition prior to cooking of the meat analogue composition.

Where the one or more alkali ingredients are used in the meat analogue compositions without being encapsulated, the one or more alkali ingredients may be mixed into the meat analogue composition or applied to the surface of the meat analogue composition in the food product. The one or more alkali ingredients improve the tenderness and heterogenous browning after cooking of the meat analogue composition in the food product. As discussed above, these advantages are also provided when the one or more alkali ingredients are encapsulated.

Where the meat analogue composition comprises one or more reducing sugars, the use of the third and fourth aspects of the invention may comprise using the one or more alkali ingredients and the one or more sugars to provide a heterogeneous browning effect, as discussed in further detail above.

### Processes of Manufacture

According to a fifth aspect of the invention, there is provided a process of manufacturing a meat analogue composition or a food product as described herein, wherein the process comprises: combining water; non-animal protein; a fat composition; one or more alkali ingredients; one or more colourants; and optionally one or more additional components so as to form the meat analogue composition; and optionally forming the meat analogue composition into food products.

Preferably, the process comprises:
(a) providing a mixture of water; non-animal protein; one or more colourants; and optionally one or more additional components;
(b) combining the mixture from step (a) with the fat composition and one or more alkali ingredients to form the meat analogue composition; and
(c) optionally forming the meat analogue composition into food products.

Typically, the process further comprises blending (i) the mixture of water; non-animal protein; one or more colourants and one or more optional additional components provided in step (a); and/or (ii) a mixture formed in step (b) by combining the mixture from step (a) with the fat composition and one or more alkali ingredients.

In an example, the fat composition is not melted upon combining with the mixture from step (a). This is particularly preferred when the fat composition is being used to encapsulate the one or more alkali ingredients within the fat matrix of the fat composition. This is because if the fat composition is melted upon mixing with the other ingredients of the meat analogue composition, there is an increased chance that the one or more alkali ingredients lose some of their encapsulation and are able to interact with the one or more colourants which is not desirable.

Preferably, the process further comprises cooking the food product to form a cooked food product or partially cooked food product.

Whilst the above described steps are preferable steps for manufacturing the meat analogue compositions or food products described herein, it will be appreciated that other suitable processes may also be used to manufacture the meat analogue compositions and food products.

The meat-analogue composition of the present invention may be readily prepared by blending a fat composition as described herein with plant protein and any other components of the composition. By way of example, a process for preparing a meat-analogue composition may comprise the step of forming the meat-analogue composition by blending a plant protein with a fat composition as described herein. Optionally, further ingredients may be present. Water may be added to the composition if required at any stage during the process. The process may further comprise the step of preparing the plant protein by providing a dry phase comprising plant protein and blending the dry phase with an amount of water, which precedes the step of forming the meat-analogue composition. This step may also include other ingredients which are in dry form, such that these dry ingredients are hydrated simultaneously with the plant protein. Additionally and/or alternatively, any other dry ingredients may be hydrated separately from the plant protein in any combination. Where TVPs are included, the TVP is preferably hydrated separately from any other dry ingredients. Without being bound by theory, this is believed to limit competition between the dry components for the water and ensure satisfactory hydration for all dry components present.

Thus, disclosed herein is a process for preparing a meat-analogue composition, said process comprising the steps of: a) providing a dry phase comprising plant protein and optionally any other dry ingredients of the composition and blending the dry phase with an amount of water to form a mixture; b) forming the meat-analogue composition by blending the mixture formed in step a) with a fat composition as described herein. The plant protein may comprise TVPs. Preferably, dry ingredients other than the TVP are hydrated separately from the TVP. Examples of such dry ingredients include, but are not limited to, fibres, flavours, emulsifiers, gums, hydrocolloids, thickeners, plant protein isolate and powdered colourants. Preferably, the mixture of step a) comprising the hydrated plant protein and any other mixtures comprising hydrated dry ingredients are combined prior to step b). Without being bound by theory, it is believed that the hydration of dry ingredients prior to the addition of the fat composition (for example, in step a)) results in an optimal distribution of water in the product, resulting in a more stable meat-analogue composition.

The dry phase comprising plant protein used in the above process is not particularly limited. The plant protein is as described hereinabove. The term ‘dry phase’ is intended to mean that the phase comprising plant protein comprises less than 5 wt. % water, preferably less than 2 wt. % water, more preferably less than 1 wt. % water, even more preferably that it is substantially free from water. The aw of the dry phase may be 0.90 or lower, more preferably below 0.80. The dry phase comprising plant protein is typically provided in a substantially dehydrated state to reduce microbial growth as far as possible so as to extend shelf life.

The dry phase, which may comprise plant protein, may take any physical form before being blended with water, however typically it is in powder, granule or pelletized, strip or chunk form. The amount of water added to the dry phase is not particularly limited. Typically, an amount of water is added in order to bind the dry components into a paste or dough with which the fat composition may be readily blended. The amount of water added to the dry phase is preferably calculated such that the total amount of water in the meat-analogue composition after addition of the other components of the fat composition are within the ranges described above.

The temperature of the water added is not particularly limited, so long as it does not materially impact the intended characteristics of the components (e.g. does not lead to protein denaturation or hydrolysis). Preferably, the water is below room temperature (i.e. below 20° C.). More preferably, ice water is used. This is particularly preferred when water is added to the dry phase. The term “ice water” is defined herein as having a temperature of above 0° C. and below 6° C., preferably from 0.5 to 5° C., more preferably from 1 to 4° C., more preferably from 1 to 3° C. An advantage of using ice water is that it slows microbial growth as far as possible during preparation of the meat-analogue composition and it is particularly suitable for the hydration of certain dry ingredients as methylcellulose.

The blending of the dry phase with water may be performed for any duration of time. For example, blending may be performed until the dry phase and water are intimately mixed and typically until a paste or dough is formed. Where TVPs are hydrated, blending is limited to a minimum so as not to overly disturb the fibrous structures. Preferably, this may be performed for a duration of from 1 second to 30 minutes, preferably from 1 second to 10 minutes, more preferably from 5 seconds to 5 minutes.

Following blending of the dry phase and water, for example in step a), the mixture may be allowed to rest prior to the addition of the fat composition, for example in step b). This may ensure full hydration of the dry phase prior to addition of the fat composition. This rest may be performed under cold storage (thereby further controlling microbial growth), which has a temperature of from 0.5 to 15° C., preferably from 1 to 12° C., more preferably from 5 to 10° C. This rest may be performed for a duration of from 5 minutes to 5 hours, preferably from 5 minutes to 2 hours, more preferably from 5 minutes to 30 minutes.

Preparation of the meat-analogue composition may also comprise the step of adding further ingredients to the composition. These ingredients may be added at any stage in the preparation of the meat-analogue composition. By way of example, further ingredients may be added after the addition of the fat composition, for example after step b). Preferably, dry ingredients are hydrated prior to addition to the fat composition. By way of further example, dry ingredients may be hydrated with any dry plant protein, such as in step a), prior to the addition of the fat composition. Such ingredients may include one or more of carbohydrates, polysaccharides, modified polysaccharides, hydrocolloids, gums, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, starch, salt, spices, fibre, flavour components, colourants, thickening and gelling agents, egg powder, enzymes, gluten, vitamins, preservatives, sweeteners, oxidising agents, reducing agents, anti-oxidants, and acidity regulators, as disclosed in more detail herein. The addition of these ingredients may be performed by blending, mixing or any suitable means.

Once the meat-analogue composition has been prepared, this may be formed into a food product. This may include the step of forming the meat-analogue composition into the desired shape. The shape and size of the resulting food product is not particularly limited.

Examples of shaped food products which can be made from the meat-analogue composition according to the present invention include burgers, sausages, nuggets, meatballs and mince.

Any suitable method may be used to shape the meat-analogue composition into the desired shape. By way of example, this may be performed by cutting, moulding, pressing, extrusion, rolling, grinding or any combination thereof. These processes may be performed using an apparatus, which may be operated manually or may be automated. The meat-analogue composition may be compressed for 5 minutes to 24 hours, preferably 1 hour to 12 hours, more preferably 3 hours to 8 hours. The duration and pressure of compression is determined by the desired properties of the resulting food product, such as its size and density, taking into account the properties of the meat-analogue composition, such as adhesiveness, among other factors. This may form the desired shape of the food product, or it may be further processed such as by pelletizing, grinding or cutting, for instance to replicate the attributes of ground/minced meat.

The process of preparing a meat-analogue composition may further comprise cooking or part-cooking the composition, which may have been formed into a food product. Cooking may comprise boiling, baking, frying and/or microwaving. Preferably, cooking is at sufficient temperature such that the Maillard reaction may occur (for example, above 80° C. and up to 180° C., preferably from 130° C. to 170° C.). The Maillard reaction is useful for desirable browning of the food product.

### Fats for Use

According to a sixth aspect of the invention, there is provided a non-animal derived fat composition comprising one or more encapsulated alkali ingredients present in an amount of from 0.005% to 40% by weight of the fat composition.

Preferably, the one or more alkali ingredients and fat composition are as described above.

Preferably, the one or more alkali ingredients are dispersed within a fat matrix of the fat composition. By way of example, the one or more alkali ingredients may comprise one or more alkali ingredients encapsulated by a coating so as to be coated alkali ingredients; and the coated alkali ingredients are further encapsulated in a fat matrix of the fat composition.

Preferably, the one or more alkali ingredients are present in the fat composition in an amount of from 1% to 20% by weight of the fat composition.

Where the one or more alkali ingredients are encapsulated in a coating, the one or more alkali ingredients are typically present in the fat composition in an amount of from 1% to 20% by weight; and preferably 10% to 20% by weight such as 10% to 15% by weight. The reference to the weight percentage of the one or more alkali ingredients refers to the weight of the alkali ingredients themselves, and not the coating of the one or more alkali ingredients, if present.

Where the one or more alkali ingredients are not encapsulated in a coating, the one or more alkali ingredients are typically present in the fat composition in an amount of from 1% to 15% by weight. The fat compositions may be prepared by any suitable methods such as the methods discussed above.

### DESCRIPTION OF THE DRAWINGS

FIG. 1 depicts photographs of an animal meat burger before and after cooking.

FIG. 2 depicts photographs of a prior art meat analogue burger before and after cooking. It can be seen that whilst the cooked burger has a brownish colour, the raw burger is an undesirable pale pink colour and does not accurately mimic the red colour of raw real meat (as shown in FIG. 1).

FIG. 3 depicts photographs of a prior art meat analogue burger before and after cooking. It can be seen that the raw burger has an orange tinge which colour is maintained after the burger is cooked.

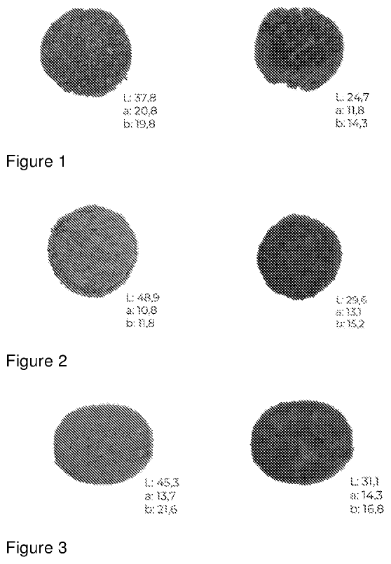

### DETAILED DESCRIPTION OF THE INVENTION

The following examples are for illustrative purposes only, and are not intended to limit the scope of the invention in any way.

### Example 1

Meat analogue compositions were prepared and formed into plant-based burgers A, B and C. The components present in the meat analogue compositions used to form burgers A, B and C are shown in the table below.

| | A | B | C |
|---|---|---|---|
| | Amount | Amount | Amount |
| | (wt. %) | (wt. %) | (wt. %) |
| Water (5° C.) | 40.7 | 39.5 | 40.3 |
| Textured proteins * | 16.4 | 15.9 | 16.2 |
| Fat A ** | 11.7 | 12.3 | 11.6 |
| Sodium bicarbonate | 0.0 | 0.9 | 0.9 |
| Dextrose | 0.0 | 0.9 | 0.0 |
| Methylcellulose (Benecel MX) | 1.8 | 0.0 | 1.8 |
| Methylcellulose (Methocel MX) | 0.0 | 1.8 | 0.0 |
| Ice water (1° C.) | 22.5 | 21.9 | 22.3 |
| Pea fiber (I50M) | 0.9 | 0.9 | 0.9 |
| Pea protein (Nutralys F85F) | 3.3 | 3.2 | 3.2 |
| Garlic powder | 0.3 | 0.3 | 0.3 |
| Salt | 0.2 | 0.2 | 0.2 |
| Black pepper | 0.1 | 0.1 | 0.1 |
| Beef Roasted Flavor | 0.4 | 0.4 | 0.4 |
| Exberry Shade Fiesta Pink | 1.0 | 1.0 | 1.0 |
| Exberry Shade Brilliant orange | 0.4 | 0.4 | 0.4 |
| Exberry Shade Bleu - HP | 0.4 | 0.4 | 0.4 |

* The textured proteins used were a combination of textured pea protein (Nutralys T70S-EXP) (83%) and textured fava protein (Nutralys TF-C) (17%).
** Fat A is a fat prepared by chemical interesterification of a blend of 70 wt % shea butter and 30 wt % coconut oil.

The burger patties were each prepared by the following procedure:
Textured proteins are blended with water at 5° C. and kept for 30 minutes at 5° C. to fully hydrate the textured proteins.
   After 30 minutes, the hydrated textured proteins are chopped for 20 seconds in a KitchenAid food chopper.
Dry powdered ingredients are blended; ice water is added and mixed for 1 min at Speed 1 in a Hobart mixer. The mixture (Mix 1) is then kept at 5° C. for 30 minutes.
The chopped hydrated textured proteins, fats/oils and colors are added to Mix 1 and blended for 2 minutes in a Hobart mixer at speed 1. This results in Mix 2, which is kept at 5° C. for another 30 minutes.
After 30 minutes, Mix 2 is taken out of the fridge. Mix 2 is divided into 100 g parts, which are shaped into burger patties of 8 cm diameter and approximately 2 cm height.
The burger patties are covered with plastic foil and stored at 5° C. until analysis (after 1 day and after storage)

Measurements were then carried out on each of the raw burgers before the raw burgers were cooked and tests carried out upon the cooked burgers.

The measurements and cooking were carried out by the following procedures:
Color measurement of the raw burger with a BYK color-guide 45/0 color meter is obtained
Texture profile analysis (TPA) of raw burger: The sample is compressed two times with a probe of 25 mm diameter placed in the middle of a complete burger to 5 mm depth, with 5 seconds waiting time in between compressions. Pre-test speed is 1 mm/s, test and post-test speed are 5 mm/s. The tests were conducted using a TA.XT plus texture analyser (available from Stable Micro Systems).
pH of the raw burger is measured using a pH probe (Sartorius PB-11) inserted directly into the burger
The burger is fried for 6 minutes in a pan with 5 g of sunflower oil, on an induction cooker at 800 W. The weight of the pan and burger are noted before and after frying.
Color measurement of the surface of the fried burger with a BYK color-guide 45/0 color meter is obtained
TPA of the fried burger
pH of the fried burger is measured

The results of the measurements are shown in the tables below.

TABLE 1.1
Colour measurement of plant-based
burgers, before and after frying.

| | A | B | C |
|---|---|---|---|
| Sample before | | | |
| frying | | | |
| L* | 43.92 | 40.99 | 40.57 |
| a* | 23.73 | 16.14 | 17.35 |
| b* | 17.14 | 15.41 | 13.74 |
| Sample after | | | |
| frying | | | |
| L* | 32.16 | 21.87 | 32.33 |
| a* | 23.64 | 17.53 | 12.72 |
| b* | 16.30 | 20.78 | 16.76 |

In colour measurement, L* represents lightness of the sample (0 (darkest) to 100 (lightest)); a* represents colour on the green-red axis (more negative value is more green, more positive value is more red); and b* represents colour on the blue-yellow axis (more negative is more blue, more positive is more yellow).

Sample A has a high a* value after frying, which relates to red colour. In samples B and C, the at value is lower after frying, and this relates to a less red, more brown colour. When sodium bicarbonate and dextrose are combined (as in sample B), L* value, which refers to lightness, is also lower after frying. This is related to darker brown spots on the burger surface. When only sodium bicarbonate is added, without dextrose, the surface of the burger after frying has a homogenous brown colour without dark spots. Therefore, sodium bicarbonate is responsible for a homogenous brown colour, while dextrose and sodium bicarbonate are responsible for heterogeneous browning.

### Example 2

Meat analogue compositions were prepared and formed into plant-based burgers A and B. The components present in the meat analogue compositions used to form burgers A and B are shown in the table below.

| | A | B |
|---|---|---|
| | Amount | Amount |
| | (wt. %) | (wt. %) |
| Water (5° C.) | 40.4 | 40.4 |
| Textured proteins * | 16.2 | 16.2 |
| Fat A ** | 11.6 | 0.0 |
| Fat A with 6% sodium bicarbonate *** | 0.0 | 12.3 |
| Sodium bicarbonate | 0.7 | 0.0 |
| Methylcellulose (Methocel MX) | 1.8 | 1.8 |
| Ice water (1° C.) | 22.3 | 22.3 |
| Pea fiber (I50M) | 0.9 | 0.9 |
| Pea protein (Nutralys F85F) | 3.2 | 3.2 |
| Salt | 0.2 | 0.2 |
| Beef Roasted Flavor | 0.4 | 0.4 |
| Exberry Shade Fiesta Pink | 1.0 | 1.0 |
| Exberry Shade Brilliant orange | 0.4 | 0.4 |
| Exberry Shade Bleu - HP | 0.4 | 0.4 |
| Citric acid | 0.3 | 0.3 |

* The textured proteins used were a combination of textured pea protein (Nutralys T70S-EXP) (83%) and textured fava protein (Nutralys TF-C) (17%).
** Fat A is a fat prepared by chemical interesterification of a blend of 70 wt % shea butter and 30 wt % coconut oil.
*** This material was made by dispersing sodium bicarbonate in molten fat; and then crystallising it in a margarine processing unit.

The burger patties were each prepared by the following procedure:
0.7% (w/w) citric acid is pre-dissolved in water, which is then cooled to 5° C.
Textured proteins are blended with water at 5° C. and kept for 30 minutes at 5° C. to fully hydrate the textured proteins.
   After 30 minutes, the hydrated textured proteins are chopped for 20 seconds in a KitchenAid food chopper.
Dry powdered ingredients are blended, ice water is added and mixed for 1 min at Speed 1 in a Hobart mixer. The mixture (Mix 1) is then kept at 5° C. for 30 minutes.
The chopped hydrated textured proteins, fats/oils and colours are added to Mix 1, and blended for 2 minutes in a Hobart mixer at speed 1. This results in Mix 2, which is kept at 5° C. for another 60 minutes.
After 60 minutes, Mix 2 is taken out of the fridge. Mix 2 is divided into 100 g parts, which are shaped into burger patties of 8 cm diameter and approximately 2 cm height.
The burger patties are stored in closed plastic containers at 5° C. until analysis (after 1 day and after storage)

The measurements and cooking were carried out by the following procedures:
Colour measurement of the raw burger with a BYK colour-guide 45/0 colour meter
Texture profile analysis (TPA) of raw burger: The sample is compressed two times to 5 mm depth, with 5 seconds waiting time in between compressions. Pre-test speed is 1 mm/s, test and post-test speed are 5 mm/s.
pH of the raw burger is measured using a pH probe (Sartorius PB-11) inserted directly into the burger
The burger is fried for 10 minutes in a pan with 5 g of sunflower oil, on an induction cooker at 650 W. The weight of the pan and burger are noted before and after frying.
Colour of the surface of the fried burger is measured.
TPA of the fried burger
pH of the fried burger is measured

The results of the measurements are shown in the tables below.

TABLE 2.1
Colour measurement of plant-based burgers, before and
after frying, either 1 day or 7 days after production.

| | A - 1 day | B - 1 day | A - 7 days | B - 7 days |
|---|---|---|---|---|
| Before frying | | | | |
| L* | 40.88 | 42.04 | 43.16 | 43.05 |
| a* | 21.81 | 19.49 | 13.26 | 19.31 |
| b* | 16.38 | 14.28 | 14.91 | 16.58 |
| After frying | | | | |
| L* | 28.67 | 29.35 | 27.20 | 29.01 |
| a* | 18.63 | 16.25 | 16.88 | 14.31 |
| b* | 23.72 | 14.25 | 22.50 | 16.60 |

When comparing samples A and B on day 1, colour measurements are very similar. The b* value after frying is lower for sample B, which means a lower intensity of yellow hue.

Comparing the samples before frying after 7 days, the a* value of sample A has decreased significantly while that of sample B has remained the same as day 1. The a* value represents the green-red colour axis, a more positive value means a more red colour. Thus, the redness in sample A has decreased over time to a more dull, brown colour. After frying, the redness of both samples is again similar.

This example shows that when sodium bicarbonate is incorporated into a plasticized shortening, it is shielded from the other ingredients and as a result, the colour of the raw burger remains more stable during storage. Nevertheless, during frying, sodium bicarbonate is set free from the fat matrix and results in browning of the burger surface.

### Example 3

Meat analogue compositions were prepared and formed into plant-based burgers A, B and C. The components present in the meat analogue compositions used to form burgers A, B and C are shown in the table below.

TABLE 3.1
Compositions of meat analogues

| | A | B | C | D |
|---|---|---|---|---|
| | Amount | Amount | Amount | Amount |
| | (wt. %) | (wt. %) | (wt. %) | (wt. %) |
| Water (5° C.) | 40.8 | 40.5 | 40.3 | 40.5 |
| Textured protein * | 16.4 | 16.3 | 16.2 | 16.3 |
| Fat A ** | 11.7 | 11.6 | 11.6 | 11.6 |
| Coated sodium bicarbonate | 0 | 0 | 1.2 | 0 |
| (60%, TasteTech)) in burger | | | | |
| paste | | | | |
| Sodium bicarbonate in | 0 | 0.7 | 0 | 0 |
| burger paste | | | | |
| Sodium bicarbonate applied | 0 | 0 | 0 | 0.7 |
| on surface of burger | | | | |
| Methylcellulose (Methocel | 1.8 | 1.8 | 1.8 | 1.8 |
| MX) | | | | |
| Ice water (1° C.) | 22.6 | 22.4 | 22.3 | 22.4 |
| Pea fiber (I50M) | 0.9 | 0.9 | 0.9 | 0.9 |
| Pea protein (Nutralys F85F) | 3.3 | 3.3 | 3.2 | 3.3 |
| Salt | 0.2 | 0.2 | 0.2 | 0.2 |
| Beef Roasted Flavor | 0.4 | 0.4 | 0.4 | 0.4 |
| Exberry Shade Fiesta Pink | 1.0 | 1.0 | 1.0 | 1.0 |
| Exberry Shade Brilliant | 0.4 | 0.4 | 0.4 | 0.4 |
| orange | | | | |
| Exberry Shade Bleu - HP | 0.4 | 0.4 | 0.4 | 0.4 |
| Citric acid | 0.3 | 0.3 | 0.3 | 0.3 |

* The textured proteins used were a combination of textured pea protein (Nutralys T70S-EXP) (83%) and textured fava protein (Nutralys TF-C) (17%).
** Fat A is a fat prepared by chemical interesterification of a blend of 70 wt % shea butter and 30 wt % coconut oil.

The burgers were analysed; cooked and analysed again using similar procedures as described above in Example 2. The results of the tests are shown in the table below.

TABLE 3.2
Colour measurement of plant-based burgers, before
and after frying, 1 day after production.

| | A | B | C | D |
|---|---|---|---|---|
| Sample before | | | | |
| frying (1 d) | | | | |
| L* | 44.02 | 41.77 | 44.14 | 43.90 |
| a* | 25.21 | 22.71 | 24.86 | 23.15 |
| b* | 18.86 | 17.88 | 18.78 | 18.96 |
| Sample after | | | | |
| frying (1 d) | | | | |
| L* | 31.74 | 29.37 | 28.10 | 22.46 |
| a* | 24.91 | 14.62 | 13.38 | 15.50 |
| b* | 18.39 | 16.20 | 12.15 | 18.63 |

TABLE 3.3
pH measurements of plant-based burgers before
and after frying, 1 day after production.

| Sample | A | B | C | D |
|---|---|---|---|---|
| pH before frying | 6.03 | 7.04 | 6.23 | 7.09 |
| pH after frying | 5.72 | 7.50 | 7.57 | 7.25 |

When comparing colour measurements of samples A, B, C and D after frying, a* value of samples containing sodium bicarbonate (B, C and D) is lower than that of sample A. This demonstrates that the sodium bicarbonate provides a browning effect whether the sodium bicarbonate is encapsulated or not; and if not encapsulated, both when applied in the burger paste or on the surface of the burger. Thus, samples B, C and D have a brown colour after frying. Sample C contains encapsulated sodium bicarbonate, where the sodium bicarbonate is initially hidden in the coating, and is released upon heating. This is clear from the pH measurements, where pH of sample C increases with 1 pH point over the course of frying, while that of the other samples remain similar before and after frying.

Furthermore, when looking at the measurements of raw colour, it is clear that in samples B and D, the red colour is partly broken down due to the presence of sodium bicarbonate, resulting in a lower a* value than sample A without sodium bicarbonate. In sample C however, the a* value is similarly high to sample A, thus showing that encapsulation of sodium bicarbonate results in protection of the raw meat colour.

TABLE 3.4
Hardness of meat analogues measured by texture profile analysis,
before and after frying, 3 days after production.

| | Sample A | Sample B | Sample C | Sample D |
|---|---|---|---|---|
| Hardness before | 1146 (138) | 1201 (116) | 815 (12) | 927 (30) |
| frying | | | | |
| Hardness after | 950 (52) | 654 (28) | 445 (51) | 631 (27) |
| frying | | | | |

Range of two measurements on separate burgers is given between brackets

In addition to the effect on color, it is clear from Table 3.4 that all samples containing sodium bicarbonate (whether the sodium bicarbonate is encapsulated or not; applied in the burger paste or on the surface of the burger) have lower hardness after frying than the comparative sample A without sodium bicarbonate. Thus, samples containing sodium bicarbonate are shown to provide improved tenderness to the cooked meat analogue composition food products.

### Example 4

TABLE 4.1
Compositions of meat analogues

| | A | B | C | D |
|---|---|---|---|---|
| | Amount | Amount | Amount | Amount |
| | (wt. %) | (wt. %) | (wt. %) | (wt. %) |
| Water (5° C.) | 40.7 | 40.4 | 40.2 | 40.2 |
| Textured proteins * | 16.4 | 16.2 | 16.2 | 16.2 |
| Fat A ** | 11.7 | 11.6 | 11.5 | 7.9 |
| Coated sodium bicarbonate | 0.0 | 0.0 | 0.0 | 4.9 |
| further encapsulated in | | | | |
| fat (Fat B) *** | | | | |
| Coated sodium bicarbonate | 0.0 | 0.0 | 1.2 | 0.0 |
| (T3514) | | | | |
| Sodium bicarbonate | 0.0 | 0.7 | 0.0 | 0.0 |
| Methylcellulose (Methocel MX) | 1.8 | 1.8 | 1.8 | 1.8 |
| Ice water (1° C.) | 22.5 | 22.3 | 22.2 | 22.2 |
| Pea fiber (I50M) | 0.9 | 0.9 | 0.9 | 0.9 |
| Pea protein (Nutralys F85F) | 3.3 | 3.2 | 3.2 | 3.2 |
| Salt | 0.2 | 0.2 | 0.2 | 0.2 |
| Beef Roasted Flavor | 0.4 | 0.4 | 0.4 | 0.4 |
| Exberry Shade Fiesta Pink | 1.0 | 1.0 | 1.0 | 1.0 |
| Exberry Shade Brilliant orange | 0.4 | 0.4 | 0.4 | 0.4 |
| Exberry Shade Bleu - HP | 0.4 | 0.4 | 0.4 | 0.4 |
| Citric acid | 0.3 | 0.3 | 0.3 | 0.3 |

* The textured proteins used were a combination of textured pea protein (Nutralys T70S-EXP) (83%) and textured fava protein (Nutralys TF-C) (17%).
** Fat A is a fat prepared by chemical interesterification of a blend of 70 wt % shea butter and 30 wt % coconut oil.
*** Fat B is a blend of a) 50% of a crystallised blend of rapeseed oil with 5.5% fully hydrogenated rapeseed oil, b) 25% rapeseed oil and c) 25% of coated sodium bicarbonate; added together and gently mixed at low speed, at a temperature below the melting temperature of the fat coating.

### Procedure

### Preparation of Meat Analogue:

The procedure and measurements are performed as outlined in Examples 2 and 3.

### Results

TABLE 4.2
Colour measurement of plant based burgers, before
and after frying, 1 day after production.

| | A | B | C | D |
|---|---|---|---|---|
| Before frying | | | | |
| (1 d) | | | | |
| L* | 45.92 | 44.60 | 45.37 | 42.83 |
| a* | 24.13 | 21.67 | 23.80 | 25.90 |
| b* | 18.46 | 18.99 | 19.51 | 19.76 |
| After frying | | | | |
| (1 d) | | | | |
| L* | 31.47 | 28.36 | 29.11 | 27.30 |
| a* | 21.78 | 14.38 | 12.81 | 13.41 |
| b* | 13.70 | 15.53 | 12.90 | 13.79 |
| Before frying | | | | |
| (7 d) | | | | |
| L* | 46.90 | 44.85 | 44.81 | 42.44 |
| a* | 21.98 | 18.81 | 20.47 | 23.58 |
| b* | 19.21 | 19.91 | 19.81 | 20.05 |
| After frying | | | | |
| (7 d) | | | | |
| L* | 30.02 | 25.81 | 28.70 | 29.42 |
| a* | 28.61 | 16.29 | 14.59 | 14.26 |
| b* | 25.92 | 20.13 | 16.85 | 17.18 |

TABLE 4.3
pH measurements of plant based burgers before and
after frying, 1 day and 7 days after production.

| | Day 1 | | | | Day 7 | | | |
|---|---|---|---|---|---|---|---|---|
| | A | B | C | D | A | B | C | D |
| pH before | 5.91 | 7.01 | 6.56 | 5.87 | 5.54 | 7.48 | 7.25 | 7.05 |
| frying | | | | | | | | |
| pH after | 5.69 | 7.64 | 7.62 | 7.40 | 5.66 | 7.31 | 7.34 | 7.36 |
| frying | | | | | | | | |

In sample A (a comparative sample without the use of an alkaline ingredient), no browning effect is obtained (a* value does not significantly decrease during frying). The pH is also low and does not change during frying.

In sample B, browning is obtained, demonstrated by a visible decrease of the a* value during frying. However, because the alkaline ingredient is not encapsulated, the raw color is broken down (demonstrated by a lower a* value than sample A at day 1 and further decrease of a* after 7 days storage). The pH is also high due to the presence of the alkaline ingredient.

Sample C contains a coated alkali ingredient. The sodium bicarbonate is better retained in the raw burger than sample B (shown by the lower pH than Sample B before frying) and no breakdown of raw colour prior to cooking (as the a* value does not decrease as strongly over time). Browning is also obtained (shown by a strong decrease of the a* value during frying). The pH also increases during frying due to the release of the alkaline ingredient.

In sample D, the alkali ingredient is even better encapsulated due to the combination of the coating of the sodium bicarbonate particle and the inclusion in the fat matrix. This results in an even better retention of the raw burger colour (almost no decrease of a* value during storage), while the browning effect is still obtained due to the release of sodium bicarbonate during frying (decrease of a* value during frying, and increase of pH).

### Example 5

TABLE 5.1
Compositions of meat analogues

| | A | B |
|---|---|---|
| | Amount | Amount |
| | (wt. %) | (wt. %) |
| Water (5° C.) | 174 | 174 |
| Textured protein * | 70 | 70 |
| Fat A ** | 34.1 | 34.1 |
| Fat B *** | 16.4 | 0 |
| Coated sodium bicarbonate further | 0 | 21.2 |
| encapsulated in fat B | | |
| Methylcellulose (Methocel MX) | 7.8 | 7.8 |
| Ice water (1° C.) | 96.2 | 96.2 |
| Pea fiber (I50M) | 4 | 4 |
| Pea protein (Nutralys F85F) | 14 | 14 |
| Salt | 0.8 | 0.8 |
| Beef Roasted Flavor | 1.6 | 1.6 |
| Exberry Shade Fiesta Pink | 1.0 | 1.0 |
| Exberry Shade Brilliant orange | 0.4 | 0.4 |
| Exberry Shade Bleu - HP | 0.4 | 0.4 |
| Citric acid | 0.3 | 0.3 |

* The textured proteins used were a combination of textured pea protein (Nutralys T70S-EXP) (83%) and textured fava protein (Nutralys TF-C) (17%)).
** Fat A is a fat prepared by chemical interesterification of a blend of 70 wt % shea butter and 30 wt % coconut oil.
*** Fat B is a crystallised blend of rapeseed oil with 6% palm stearin IV13.

### Procedure:

### Preparation of Fat Mixture Containing Coated Sodium Bicarbonate:

75% Fat B and 25% of coated sodium bicarbonate are added together and gently mixed at low speed, at a temperature below the melting temperature of the fat coating.

### Preparation of Meat Analogue:

The procedure and measurements are performed as outlined in previous examples.

### Results

TABLE 5.1
Firmness of plant based burgers before
and after frying by texture analysis

| | Sample A | Sample B |
|---|---|---|
| Firmness before frying (g) | 1046 (76) | 956 (48) |
| Firmness after frying (g) | 1630 (55) | 660 (79) |

Range of two separate measurements is given between brackets

Texture analysis shows lower firmness after frying in samples containing the encapsulated alkaline ingredient. This indicates that the compositions containing the alkali were more tender after cooking.

In a separate attributes ranking test by a sensory panel with 18 participants, sample B (containing the encapsulated alkaline ingredient) was significantly rated less firm (and thus more tender) than sample A.

1. A meat analogue composition comprising from 2.0% to 20.0% by weight of a fat composition; from 5.0% to 30.0% by weight of a non-animal protein; from 30.0% to 70.0% by weight of water; from 0.01% to 5% by weight of one or more colourants; and from 0.005% to 5% by weight of one or more alkali ingredients.

2. A meat analogue composition according to claim 1, wherein the one or more alkali ingredients are encapsulated.

3. A meat analogue composition according to claim 1, wherein the meat analogue composition comprises from 0.1% to 5% by weight of the one or more alkali ingredients.

4-6. (canceled)

7. A meat analogue composition according to claim 1, wherein the one or more alkali ingredients comprise an alkali metal salt, an alkaline earth metal salt, an ammonium salt, an amine, or a combination thereof.

8. A meat analogue composition according to claim 7, wherein the one or more alkali ingredients comprise a hydroxide, carbonate, bicarbonate, chloride, gluconate, acetate or sulfide salt of a sodium, potassium, calcium, magnesium or ammonium cation.

9-10. (canceled)

11. A meat analogue composition according to claim 1, wherein the one or more alkali ingredients are encapsulated within a fat matrix.

12. A meat analogue composition according to claim 1, wherein the one or more encapsulated alkali ingredients are encapsulated within a fat matrix of the fat composition.

13. A meat analogue composition according to claim 1, wherein the one or more alkali ingredients are encapsulated by a coating.

14. A meat analogue composition according to claim 13, wherein the coating comprises a water insoluble hydrophobic coating.

15. A meat analogue composition according to claim 13, wherein the coating is adapted to degrade at temperatures above 30° C.

16. A meat analogue composition according to claim 13, wherein the coating comprises a fat coating, a carbohydrate coating, a monoacylglyceride (MAG) coating, or a combination thereof.

17. A meat analogue composition according to claim 13, wherein the coating comprises a fat coating, and wherein the fat coating comprises a fat with a melting point of from 40° C. to 80° C.

18. A meat analogue composition according to claim 13, wherein the one or more encapsulated alkali ingredients comprise coated particles with an average particle size of less than 650 μm.

19. A meat analogue composition according to claim 13, wherein the one or more encapsulated alkali ingredients comprise coated particles with a coating thickness of from 25% to 50% of total particle thickness.

20. A meat analogue composition according to claim 1, wherein the one or more colourants are present in the meat analogue composition in an amount of from 0.5% to 2.5% by weight of the meat analogue composition.

21. A meat analogue composition according to claim 1, wherein the one or more colourants comprise natural colourants;
nature-identical colourants; synthetic colourants; colouring foodstuffs; or any combination thereof.

22-23. (canceled)

24. A meat analogue composition according to claim 1, wherein the fat composition comprises one or more non-animal derived oils.

25. A meat analogue composition according to claim 1, wherein the fat composition comprises palm oil, coconut oil, sunflower oil, or a combination thereof.

26. A meat analogue composition according to claim 1, wherein the fat composition comprises from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition.

27. A meat analogue composition according to claim 1, wherein the fat composition comprises an interesterified blend of vegetable oil and fully hydrogenated vegetable oil.

28. A meat analogue composition according to claim 1, wherein the fat composition comprises (a) a fat composition as defined in claim 26; and (b) (i) a blend of a liquid vegetable oil and a fully hydrogenated liquid vegetable oil, or (ii) a blend of a liquid vegetable oil and a vegetable oil stearin.

29. (canceled)

30. A meat analogue composition according to claim 1, wherein the meat analogue composition further comprises one or more reducing sugars.

31. A meat analogue composition according to claim 30, wherein the one or more reducing sugars are present in an amount of from 0.1% to 5% by weight of the meat analogue composition.

32. A meat analogue composition according to claim 1, wherein the nonanimal protein comprises protein derived from fungi, plants, or a combination thereof.

33-42. (canceled)

43. A meat analogue composition according to claim 1, wherein the meat analogue composition further comprises an acidity regulator.

44. A meat analogue composition according to claim 43, wherein the acidity regulator comprises citric acid.

45. A meat analogue composition according to claim 1, wherein the fat composition is present in the meat analogue composition in an amount of from 7.5% to 20% by weight of the meat analogue composition.

46. (canceled)

47. A meat analogue composition according to claim 1, wherein the meat analogue composition is substantially free of animal protein.

48. A meat analogue composition according to claim 1, wherein the meat analogue composition is substantially free of animal-derived products.

49. A meat analogue composition according to claim 1, wherein the meat analogue composition further comprises one or more animal-derived products such as animal oils, marine oils, animal-derived proteins, animal-derived polysaccharides, or any combination thereof.

50-51. (canceled)

52. A food product comprising a meat analogue composition according to claim 1.

53-64. (canceled)

65. A process of manufacturing a meat analogue composition according to claim 1, wherein the process comprises: combining water; non-animal protein; the fat composition; one or more alkali ingredients; one or more colourants; and optionally one or more additional components so as to form the meat analogue composition; and optionally forming the meat analogue composition into food products.

66-69. (canceled)

70. A non-animal derived fat composition comprising one or more encapsulated alkali ingredients present in an amount of from 0.005% to 40% by weight of the fat composition.

71-73. (canceled)
